(19) United States
(12) Patent Application Publication
(10) Pub. No.: US 2024/0424989 A1
(43) Pub. Date: Dec. 26, 2024

(54) IMAGE PROVIDING APPARATUS

(71) Applicants: TOYOTA JIDOSHA KABUSHIKI KAISHA, Toyota-shi (JP); Nomura Research Institute, Ltd., Tokyo (JP)

(72) Inventors: Yoshihiro OE, Nagoya-shi (JP); Wataru MINOURA, Nagoya-shi (JP); Masatoshi HAYASHI, Nisshin-shi (JP); Yutaro IMAMURA, Nagoya-shi (JP); Fumihiro NASU, Nagoya-shi (JP); Yuki TATSUMOTO, Seto-shi (JP); Takehiko HASHIMOTO, Chiyoda-ku (JP)

(73) Assignees: TOYOTA JIDOSHA KABUSHIKI KAISHA, Toyota-shi (JP); Nomura Research Institute, Ltd., Tokyo (JP)

(21) Appl. No.: 18/674,067

(22) Filed: May 24, 2024

(30) Foreign Application Priority Data
Jun. 20, 2023 (JP) 2023-101025

(51) Int. Cl. B60R 1/29

(52) U.S. Cl. CPC B60R 1/29; B60R 2300/108; B60R 2300/302; B60R 2300/307; B60R 2300/406; B60R 2300/50; B60R 2300/8006

(57) ABSTRACT

An image providing apparatus is connected to a plurality of vehicles each including a drive recorder and a plurality of information input apparatuses via a communication network. The image providing apparatus receives and stores data of a video image captured by the drive recorder from the plurality of vehicles and in a storage apparatus. The image providing apparatus receives information for identifying a vehicle of a user and a condition for a wanted image from the information input apparatus, the information and the condition being input to the information input apparatus by the user. The image providing apparatus extracts and provides, from among a plurality of the data of the video images stored in the storage apparatus and for the user, an image that the vehicle of the user is viewed in and matches the condition.

### CROSS-REFERENCE TO RELATED APPLICATION

This application claims priority to Japanese Patent Application No. 2023-101025 filed on Jun. 20, 2023, incorporated herein by reference in its entirety.

### BACKGROUND

### 1. Technical Field

The present disclosure relates to an image providing apparatus.

### 2. Description of Related Art

Japanese Unexamined Patent Application Publication No. 2009-9329 discloses a drive recorder. A user inputs information of a desired scene that the user wants to capture to the drive recorder. When a vehicle of the user passes through a place where a video image that matches the input conditions for the desired scene can be captured, the drive recorder records the scene during the passing-through.

### SUMMARY

Some of users who drive a vehicle want images in which the vehicle being driven by the user itself is captured from the outside of the vehicle of the user itself. However, such a user has to have a third party capture such an image with its capturing place and capturing date and time arranged.

Hereafter, means for solving the aforementioned problem and its operation and effects are described.

An image providing apparatus in order to solve the aforementioned problem is connected to a plurality of vehicles each including a drive recorder and a plurality of information input apparatuses via a communication network. The image providing apparatus includes: a processing apparatus; and a storage apparatus. In the image providing apparatus, the processing apparatus receives and stores data of a video image captured by the drive recorder from the plurality of vehicles and in the storage apparatus. Moreover, in the image providing apparatus, the processing apparatus receives information for identifying a vehicle of a user and a condition for a wanted image from the information input apparatus, the information and the condition being input to the information input apparatus by the user. Further, in the image providing apparatus, the processing apparatus extracts and provides, from among a plurality of the data of the video images stored in the storage apparatus and for the user, an image that the vehicle of the user is viewed in and matches the condition.

The image providing apparatus can provide an image regarding a vehicle that a user is driving even without its capturing place and capturing date and time arranged with a third party.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of an image providing system including an image providing apparatus of an embodiment;

FIG. 2 is a sequence chart showing a flow of processing of the image providing apparatus, a vehicle, a vehicle of a user, and the information input apparatus in the image providing system of an embodiment;

FIG. 3 is a diagram showing an example of an image provided by the image providing apparatus in the image providing system of an embodiment;

FIG. 4 is a flowchart showing a flow of processing regarding extraction of an image performed by the image providing apparatus in the image providing system of an embodiment;

FIG. 5 is a flowchart showing a flow of processing regarding providing of an image performed by the image providing apparatus in the image providing system of an embodiment; and

FIG. 6 is a flowchart showing a flow of processing performed by an information input apparatus in the image providing system of an embodiment.

### DETAILED DESCRIPTION OF EMBODIMENTS

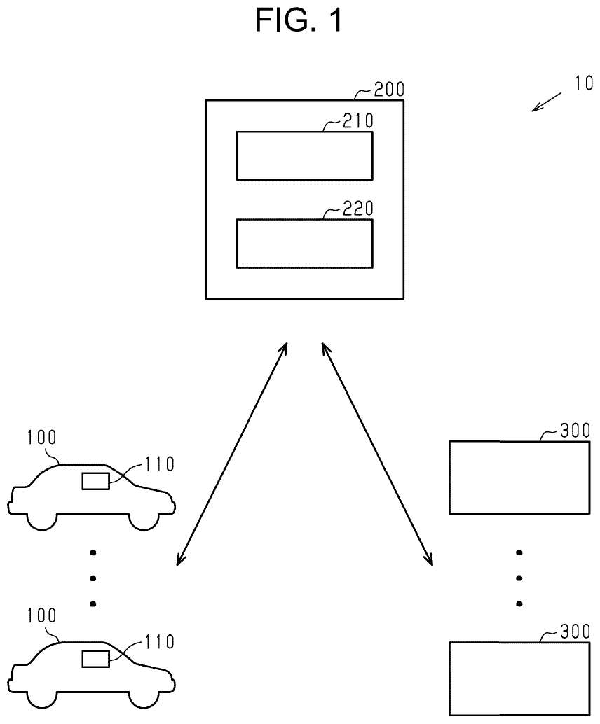

Hereafter, an embodiment of an image providing apparatus will be described with reference to FIG. 1 to FIG. 6.

### Configuration of Image Providing System 10

As shown in FIG. 1, an image providing system 10 is configured of a plurality of vehicles 100, an image providing apparatus 200, and a plurality of information input apparatuses 300.

Each vehicle 100 includes a drive recorder 110. The drive recorder 110 is configured to include an image capturing apparatus, a receiver of a satellite positioning system, and a communication apparatus.

The drive recorder 110 captures and records a video image viewed from the vehicle 100. The drive recorder 110 is installed, for example, at a front portion of the vehicle 100 and captures and records a video image ahead of the vehicle 100 viewed from a driver's seat. The drive recorder 110 may be installed, for example, at a rear portion or a lateral portion of the vehicle 100 and capture and record a video image viewed from the rear portion or the lateral portion of the vehicle 100. In other words, the drive recorder 110 may be installed at any portion of the vehicle 100 as long as it is installed to be able to capture an image of the outside of the vehicle 100.

The image providing apparatus 200 includes a storage apparatus 220 in which a program is stored, and a processing apparatus 210 that executes the program stored in the storage apparatus 220 to perform various kinds of processing. The processing apparatus 210 includes a processor.

The image providing apparatus 200 can be configured using a plurality of computers. For example, the image providing apparatus 200 can be configured of a plurality of server apparatuses.

The image providing apparatus 200 is connected to the plurality of information input apparatuses 300 and the plurality of vehicles 100 via a wireless communication network so as to transmit and receive information to/from those.

The information input apparatus 300 is configured to include an input apparatus to which a user inputs information, a display apparatus that displays information for the user, and a communication apparatus that transmits and receives information to/from the image providing apparatus 200. Notably, the user stated here means a person who desires an image to be provided from the image providing system 10. An example of the information input apparatus 300 is a device such as a smartphone that includes an application that can connect to the image providing apparatus 200.

The information input apparatus 300 transmits information input by the user to the image providing apparatus 200 and displays information received from the image providing apparatus 200 for the user. As above, the information input apparatus 300 plays a role of mediating between the user and the image providing apparatus 200.

The image providing system 10 extracts and provides, from a video image captured by the drive recorder 110 of the vehicle 100 and for the user, an image that a vehicle 101 of the user is viewed in and matches conditions, mentioned later, for an image that the user wants. The vehicle 101 of the user is a vehicle that the user drives. Hereafter, the vehicle that the user drives is expressed as the vehicle 101 of the user, and distinguished from the vehicle 100 that captures an image of the vehicle 101 of the user. Since the vehicle 101 of the user is a vehicle as a subject, it does not have to include the drive recorder 110. The vehicle 101 of the user may be one of the plurality of vehicles 100 each including the drive recorder 110.

### Transmission and Reception of Data in Image Providing System 10

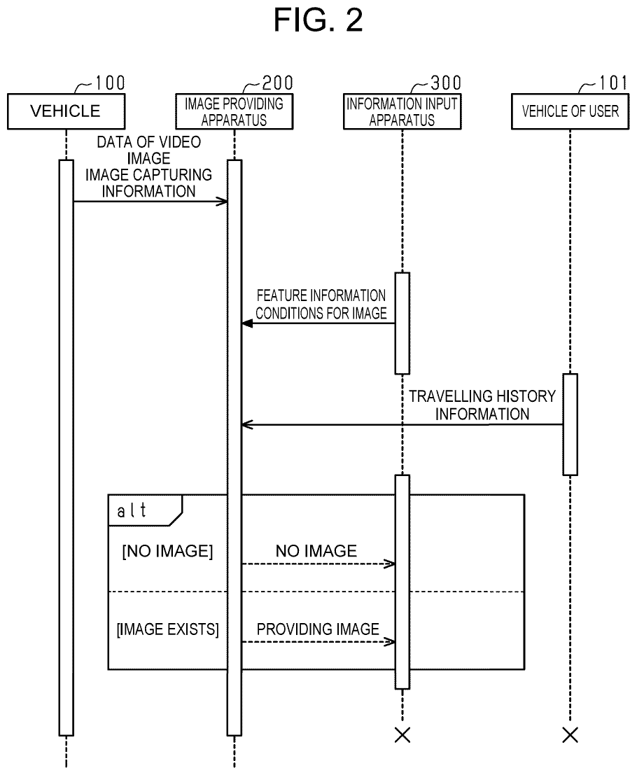

Next, transmission and reception of data from/to the image providing apparatus 200 to/from the vehicle 100, the vehicle 101 of the user, and the information input apparatus 300 are described with reference to FIG. 2.

As shown in an upper portion of FIG. 2, each vehicle 100 continues to transmit data of a video image captured by the drive recorder 110 and image capturing information to the image providing apparatus 200 during the drive recorder 110 being operating. The image capturing information includes information of capturing date and time and positional information of a capturing place of the data of the video image. Thereby, the image providing apparatus 200 can grasp when and where the video image is captured on the data of the video image. The image providing apparatus 200 having received the data of the video image stores the data of the video image in the storage apparatus 220.

As shown in the upper portion of FIG. 2, the information input apparatus 300 transmits feature information that is information for identifying the vehicle 101 of the user, and the conditions for the wanted image, the feature information and the conditions being input by the user.

An example of the feature information is information of features with which an appearance of the vehicle 101 of the user can be specified, the features being used for identifying the vehicle 101 of the user from the video image received from the vehicle 100 by the image providing apparatus 200. The feature information includes any of a vehicle type, a color, and a license number of the vehicle 101 of the user. In other words, in FIG. 2, the user transmits, as the feature information, the information including any of the vehicle type, the color, and the license number of the vehicle 101 of the user to the image providing apparatus 200.

The conditions for the wanted image are conditions that are designated by the user on an image to be provided by the image providing apparatus 200 such that the user can acquire an image of preference.

The conditions for the wanted image include information of capturing date and time and information of a capturing place of the image. As to the conditions for the wanted image, the capturing date and time of the image mean information of date and time when the drive recorder 110 of the vehicle 100 captures an image of the vehicle 101 of the user. The information of the capturing place of the image is information of a place where the drive recorder 110 of the vehicle 100 captures the image of the vehicle 101 of the user. The information of the capturing place input by the user may be positional information or may be information of a place name of the image capturing. For example, when planning a trip, the user beforehand inputs date and time of the trip to the information input apparatus 300 as the information of the capturing date and time of the image. Further, the user inputs information of the visiting place on the trip to the information input apparatus 300 as the information of the capturing place. Otherwise, for example, the user inputs information of a place where the user visited in the past to the information input apparatus 300 as the information of the capturing place. Further, the user inputs information of date and time when the user visited the place to the information input apparatus 300.

Moreover, the conditions for the wanted image can further include any of information of a background, information of an altitude of the capturing place, and information regarding an angle at which the vehicle 101 of the user is viewed in the image. In the conditions for the wanted image, while the information of the capturing date and time and the information of the capturing place of the image are essential information, the information of the background and the like are optionally included. In addition to the information of the capturing date and time and the information of the capturing place of the image, the user can input the information of the background and/or the like to the information input apparatus 300, thereby being able to designate an image to be provided by the image providing apparatus 200 more in detail.

In the conditions for the wanted image, the information of the background is information of a scene viewed behind the vehicle 101 of the user, such as a sea or a building. The information of the altitude of the capturing place is an altitude of the place where the drive recorder 110 of the vehicle 100 captures an image of the vehicle 101 of the user. An example of the information regarding the angle at which the vehicle 101 of the user is viewed in the image is information of which angle the vehicle 101 of the user is viewed at in the image.

As shown in the upper portion of FIG. 2, after receiving the feature information and the conditions for the wanted image from the information input apparatus 300, the image providing apparatus 200 receives travelling history information from the vehicle 101 of the user. The travelling history information is information in which positional information of the vehicle 101 of the user at each time is recorded. Accordingly, the image providing apparatus 200 can grasp when and where the vehicle 101 of the user travels.

The vehicle 101 of the user transmits the travelling history information that is at the capturing date and time of the image input by the user to the information input apparatus 300 as the conditions for the wanted image, to the image providing apparatus 200. In other words, the vehicle 101 of the user transmits only the travelling history information that is during the period of the capturing date and time input by the user, to the image providing apparatus 200.

After receiving the travelling history information, the image providing apparatus 200 performs extraction processing of an image from the data of the video image that is stored in the storage apparatus 220 and received from the vehicle 100. In this stage, the image extracted by the image providing apparatus 200 is an image that the vehicle 101 of the user is viewed in and matches the conditions for the wanted image. When such an image to be extracted is not found from the data of the video image received from the vehicle 100, the image providing apparatus 200 finishes the extraction processing without extracting an image. When an image to be extracted is found from the data of the video image received from the vehicle 100, the image providing apparatus 200 extracts the image and stores the extracted image in the storage apparatus 220.

As shown in the lower portion of FIG. 2, the image providing apparatus 200 having finished the extraction processing transmits data to the information input apparatus 300. Such processing is performed when the image providing apparatus 200 detects access from the information input apparatus 300. For example, such processing is performed when after the extraction processing is finished, the application of the smartphone as the information input apparatus 300 is manipulated by the user and the application accesses the image providing apparatus 200.

As shown in the lower portion of FIG. 2, the content of the data transmitted to the information input apparatus 300 varies depending on whether the image that matches the conditions is stored in the storage apparatus 220. When the image that matches the conditions is not stored in the storage apparatus 220, the image providing apparatus 200 transmits a signal indicating that there is no image that matches the conditions to the information input apparatus 300. When the image that matches the conditions is stored in the storage apparatus 220, the image providing apparatus 200 transmits data of the image for the user who desires an image to be acquired to the information input apparatus 300. As above, the image providing apparatus 200 provides the image for the user.

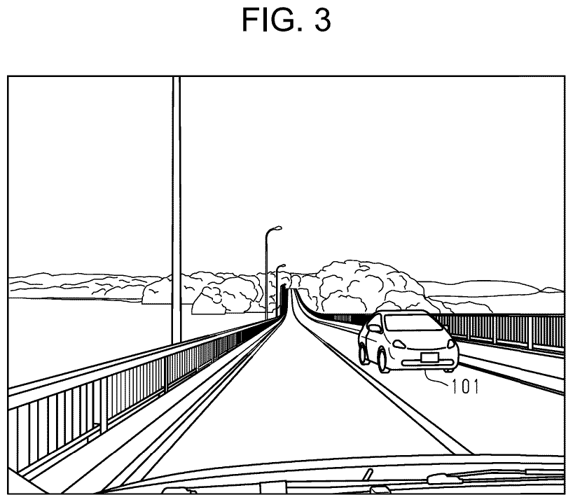

FIG. 3 is an example of the image provided for the user by the image providing apparatus 200. As to this image, the vehicle 100 captures the image, and the vehicle 101 of the user is viewed therein on the opposite traffic lane to the vehicle 100. The image providing apparatus 200 extracts and provides the image as in FIG. 3 from the storage apparatus 220 and for the user.

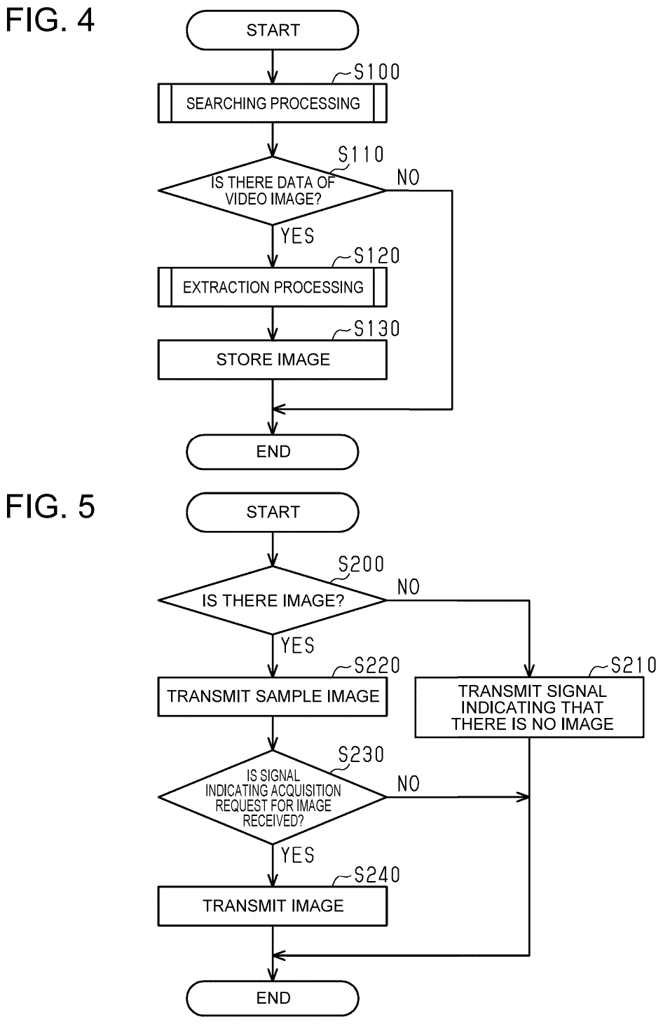

Hereafter, with reference to FIG. 4 to FIG. 6, a flow of processing performed at the image providing apparatus 200 and a flow of processing performed at the information input apparatus 300 in order to implement providing the image for the user as above are more specifically described.

### Flow of Processing Regarding Extraction of Image Performed by Image Providing Apparatus 200

FIG. 4 shows a flow of a series of processes regarding the extraction of the image performed by the image providing apparatus 200. The series of processes are performed by the processing apparatus 210 of the image providing apparatus 200 after the travelling history information is received from the vehicle 101 of the user. The series of processes correspond to processes performed after the image providing apparatus 200 receives the travelling history information from the vehicle 101 of the user in the upper portion of FIG. 2 before transmitting the data to the information input apparatus 300 in the lower portion of FIG. 2. In other words, the series of processes correspond to the extraction processing that has been described with reference to the upper portion of FIG. 2 and is performed after the image providing apparatus 200 receives the travelling history information from the vehicle 101 of the user.

As described in FIG. 4, upon the start of the series of processes, the processing apparatus 210 first performs searching processing in the process of step S100. The searching processing is processing of searching for data of a video image that has a possibility that an image that matches the conditions for the wanted image can be extracted, from among the data of the video images received from the vehicles 100.

In the searching processing, the processing apparatus 210 first extracts the travelling history information, of the user, that matches the conditions for the wanted image. As mentioned above, the vehicle 101 of the user transmits only the travelling history information that is during the period of the capturing date and time input by the user, to the image providing apparatus 200. Therefore, in the searching processing, the processing apparatus 210 extracts portions that match conditions that are based on the information of the capturing place, and the optionally included information of the background and information of the altitude of the capturing place, from the travelling history information of the vehicle 101 of the user.

In the searching processing, the processing apparatus 210 next searches for data of a video image the image capturing information of which coincides with the above-extracted travelling history information, from among the data of the video images that are received from the vehicles 100 and stored in the storage apparatus 220. By such searching processing, the processing apparatus 210 can narrow down the range where an image that matches the conditions is searched for from among the plurality of data of the video images received from the plurality of vehicles 100.

In the next step S110, the processing apparatus 210 determines whether or not there is data of a video image that is narrowed down by the searching processing. In other words, the processing apparatus 210 determines whether or not data of a video image that has a possibility that an image that matches the conditions can be extracted. In the process of step S110, when it is determined that there is the relevant data of the video image (step S110: YES), the process is put forward to step S120. In the process of step S120, the processing apparatus 210 performs extraction processing. The extraction processing is processing of extracting an image to be provided for the user from among the data of the video image that is narrowed down by the searching processing.

In the extraction processing, the processing apparatus 210 extracts an image that the vehicle 101 of the user is viewed in from the video image narrowed down by the searching processing. In this stage, the processing apparatus 210 searches for the vehicle 101 of the user from the video image using the aforementioned feature information including any of the vehicle type, the color, and the license number of the vehicle 101 of the user.

The image extracted by the processing apparatus 210 in the extraction processing is the image that satisfies the conditions for the wanted image. Therefore, for example, when the conditions for the wanted image include the information of the angle of the vehicle 101 of the user, the processing apparatus 210 extracts the image that satisfies this condition. The image extracted by the processing apparatus 210 in the extraction processing is preferably one in which the vehicle 101 of the user is viewed clear. Therefore, for example, the processing apparatus 210 extracts an image that focuses on the vehicle 101 of the user or an image in which the vehicle 101 of the user is viewed large.

For example, the extraction processing may be processing of the processing apparatus 210 showing an operator the video image narrowed down by the searching processing to cause the operator to extract the image. For example, the extraction processing may be processing of the processing apparatus 210 recognizing an object that is viewed in the video image received from the vehicle 100 by image recognition processing to extract the image. In this case, the processing apparatus 210 extracts the image that matches predefined conditions such as the size of the vehicle 101 of the user in the image. In the next step S130 after the extraction processing is performed as above, the processing apparatus 210 stores the data of the image extracted by the extraction processing in the storage apparatus 220. When finishing the processing of step S130, the processing apparatus 210 of the image providing apparatus 200 finishes the series of processes.

On the other hand, in the process of step S110, as a result of the narrowing-down by the searching processing, when it is determined that there is no data of a video image as a target of the extraction processing (step S110: NO), the processing apparatus 210 finishes the series of processes. In other words, when there is no data of a video image that has a possibility that an image that matches the conditions can be extracted, the processing apparatus 210 finishes the series of processes without extracting an image.

### Processing Performed by Image Providing Apparatus 200 That Detects Access from Information Input Apparatus 300

FIG. 5 shows a series of processes performed, after the series of processes that are shown in FIG. 4 are finished, by the image providing apparatus 200 when access from the information input apparatus 300 is detected. These series of processes are performed by the processing apparatus 210 of the image providing apparatus 200. These series of processes correspond to the processes performed when the image providing apparatus 200 transmits the data to the information input apparatus 300 after finishing the extraction processing as shown in the lower portion of FIG. 2.

As shown in FIG. 5, upon the start of these series of processes, the processing apparatus 210 determines the presence or absence of an extracted image in the process of step S200. Specifically, the processing apparatus 210 determines whether data of an image extracted by the extraction processing in step S120 in FIG. 4 is stored in the storage apparatus 220. When the relevant data of an image is not stored in the storage apparatus 220, the processing apparatus 210 determines that there is no image. When the relevant data of an image is stored in the storage apparatus 220, the processing apparatus 210 determines that there is an image.

In the process of step S200, when the processing apparatus 210 determines that there is an image (step S200: YES), the process is put forward to step S220. In the process of step S220, the processing apparatus 210 transmits data of a sample image of the relevant image to the information input apparatus 300. In this stage, when extracting a plurality of images in the extraction processing in step S120 in FIG. 4 and storing these in the storage apparatus 220, the image providing apparatus 200 transmits data of sample images of all the extracted plurality of images to the information input apparatus 300. The sample image is an image that is obtained by processing a part of its original image and transmitted for reporting what the extracted image looks like to the user. For example, an image having the characters “SAMPLE” given to the edge of its original image can be the sample image.

In the process of the next step S230, the processing apparatus 210 determines whether a signal indicating an acquisition request for an image by the user is received from the information input apparatus 300. In the process of step S230, when the processing apparatus 210 determines that the signal indicating the acquisition request is received from the information input apparatus 300 (step S230: YES), the process is put forward to step S240.

In the process of the next step S240, the processing apparatus 210 transmits the data of the image to the information input apparatus 300. The transmitted data of the image is data of an image that the user desires to acquire among images that correspond to the data of the sample images transmitted to the information input apparatus 300 in step S220. As above, the image providing apparatus 200 transmits the data of the image that the user desires to acquire to the information input apparatus 300 thereby to provide the image for the user.

When finishing the process of step S240, the processing apparatus 210 of the image providing apparatus 200 finishes these series of processes.

In the process of step S200, when the processing apparatus 210 determines that there is no relevant image (step S200: NO), the process is put forward to step S210. In the process of step S210, the processing apparatus 210 transmits a signal indicating that there is no image that matches the desired conditions to the information input apparatus 300. When the signal indicating that there is no image that matches the desired conditions is transmitted as above, the processing apparatus 210 finishes these series of processes as they are.

In the process of step S230, when the processing apparatus 210 determines that the signal indicating the acquisition request for an image is not received from the information input apparatus 300 (step S230: NO), the processing apparatus 210 finishes these series of processes. In other words, when not receiving the signal indicating the acquisition request for an image, the processing apparatus 210 finishes these series of processes as they are.

### Processing Performed by Information Input Apparatus 300

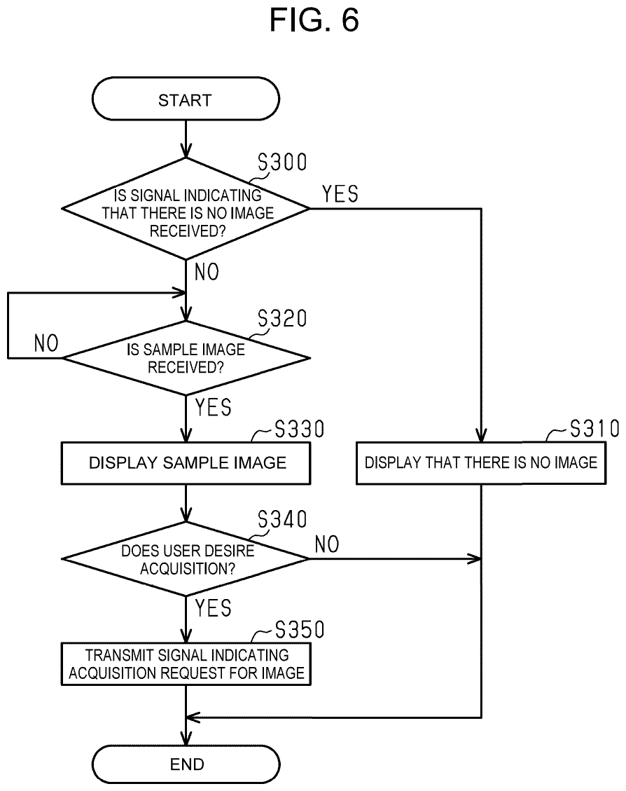

FIG. 6 shows a flow of a series of processes performed by the information input apparatus 300 having accessed the image providing apparatus 200 after the image providing apparatus 200 finishes the series of processes in FIG. 4. These series of processes present the processing of the information input apparatus 300 receiving data from the image providing apparatus 200 in the lower portion of FIG. 2.

As shown in FIG. 6, upon the start of these series of processes, first, in the process of step S300, the information input apparatus 300 determines whether the signal indicating that there is no image is received from the image providing apparatus 200.

In the process of step S300, when the information input apparatus 300 determines that the signal indicating that there is no image is not received (step S300: NO), the process is put forward to step S320.

In step S320, the information input apparatus 300 determines whether data of a sample image is received from the image providing apparatus 200. In the process of step S320, when the information input apparatus 300 determines that data of a sample image is not received (step S320: NO), the process of step S320 is repeated.

In the process of step S320, when the information input apparatus 300 determines that data of a sample image is received (step S320: YES), the process is put forward to step S330. In the process of step S330, the information input apparatus 300 displays the sample image received from the image providing apparatus 200 for the user.

In the process of the next step S340, the information input apparatus 300 determines whether the user makes a manipulation of presenting the intention of desiring acquisition on the sample image displayed in step S330. In other words, after displaying the sample image received from the image providing apparatus 200, the information input apparatus 300 inquires whether or not acquisition of the image corresponding to the displayed sample image is desired.

For example, the information input apparatus 300 displays a message on the display apparatus to request an answer to whether or not acquisition of the image is desired. When in response to this inquiry, the user makes a manipulation of presenting the intention of desiring the acquisition, the information input apparatus 300 determines that the user desires to acquire the image. On the other hand, when the user makes a manipulation of presenting the intention of not desiring the acquisition, the information input apparatus 300 determines that the user does not desire to acquire the image.

Moreover, when the data of the plurality of sample images are received from the image providing apparatus 200, there may be employed, for example, a configuration that the information input apparatus 300 has the image desired to be acquired selected from among the plurality of images corresponding to the plurality of sample images displayed for the user. In this case, when the user selects the image to want to acquire, the information input apparatus 300 determines that the selected image is desired to be acquired. When the user selects none of the images, the information input apparatus 300 determines that the user does not desire to acquire an image.

In the process of step S340, when the information input apparatus 300 determines that the user desires to acquire the image (step S340: YES), the process is put forward to step S350. In the process of step S350, the information input apparatus 300 transmits a signal indicating the acquisition request for the image to the image providing apparatus 200. The information input apparatus 300 having transmitted the signal finishes these series of processes. Notably, after transmitting the signal, the information input apparatus 300 receives and stores the data of the image from the image providing apparatus 200.

In the process of step S300, when the information input apparatus 300 determines that the signal indicating that there is no image that matches the desired conditions is received (step S300: YES), the process is put forward to step S310. In the process of step S310, the information input apparatus 300 displays that there is no image that matches the desired conditions for the user. When that there is no image that matches the desired conditions is displayed as above, the information input apparatus 300 finishes these series of processes as they are.

In the process of step S340, when the information input apparatus 300 determines that the user does not desire to acquire the image (step S340: NO), the information input apparatus 300 finishes these series of processes. Namely, in this case, the information input apparatus 300 finishes these series of processes without performing the process of step S350.

### Operation of Present Embodiment

The image providing apparatus 200 extracts and provides, from among the plurality of video images captured by the drive recorders 110 of the plurality of vehicles 100 and for the user, an image that the vehicle 101 of the user is viewed in and matches the conditions for the wanted image.

### Effects of Present Embodiment

(1) The image providing apparatus 200 can provide an image regarding the vehicle 101, of the user, that is driven by the user and is travelling for the user even without its capturing place and capturing date and time arranged with a third party.

(2) The conditions used for extracting the image include any of the information of the background, the information of the altitude of the capturing place, and the information regarding the angle at which the vehicle 101 of the user is viewed in the image. Therefore, the user can narrow down the image that matches the desired conditions by designating, as the conditions for the wanted image, the information of the background, the altitude of the capturing place, and/or the angle at which the vehicle 101 of the user is viewed in the image.

(3) The travelling history information is the information in which the positional information of the vehicle 101 of the user at each time is recorded. The processing apparatus 210 performs the searching processing using the travelling history information received from the vehicle 101 of the user and the image capturing information received from the plurality of vehicles 100. In the searching processing, the processing apparatus 210 searches for the data of the video image that has a possibility that an image that matches the conditions can be extracted, from among the plurality of data of the video images stored in the storage apparatus 220, based on these pieces of information. Therefore, comparing the travelling history information of the vehicle 101 of the user with the image capturing information, the image providing apparatus 200 can narrow down the data of the video image that has a possibility that the vehicle 101 of the user is viewed in the image, from among the plurality of data of the video images received from the plurality of vehicles 100. In other words, the image providing apparatus 200 can narrow down the range where an image that matches the conditions is searched for. Thereby, the image providing apparatus 200 can quickly extract the image that matches the conditions.

(4) The processing apparatus 210 receives, as the information for identifying the vehicle 101 of the user, the information including any of the vehicle type, the color, and the license number of the vehicle 101 of the user from the information input apparatus 300. Further, the processing apparatus 210 extracts the image that the vehicle 101 of the user is viewed in from among the data of the video image using the information including any of the vehicle type, the color, and the license number of the vehicle 101 of the user. Any of the information of the vehicle type, the color, and the license number of the vehicle 101 of the user can be a clue for identifying the vehicle 101 of the user. The image providing apparatus 200 extracts the image from among the plurality of data of the video images using the information including any of the vehicle type, the color, and the license number of the vehicle 101 of the user. Therefore, the image providing apparatus 200 can provide the image that the vehicle 101 of the user is viewed in for the user.

### Modifications

The present embodiment can be modified and implemented as below. The present embodiment and the following modifications can be combined and implemented in any manner that does not cause technical conflict between them.

In the process of step S240, for example, the processing apparatus 210 can also provide the image for the user by printing the image that the user desires to acquire on paper and sending the paper by post. In the process of step S240, for example, the processing apparatus 210 may provide the image in another electromagnetic manner such as sending data of the image that the user desires to acquire to the user by electronic mail.

In the image providing system 10, the image providing apparatus 200 provides the image that is a still image for the user. The image providing apparatus 200 may provide a moving image that matches the conditions desired by the user instead. In this case, in step S120 of the series of processes described with FIG. 4, the image providing apparatus 200 extracts data of a moving image that the vehicle 101 of the user is viewed in and matches the conditions desired by the user.

In the image providing system 10, as shown in step S220 to step S240 in FIG. 5, the image providing apparatus 200 transmits the data of the sample image. After that, after receiving the signal indicating the acquisition request for the image from the information input apparatus 300, the image providing apparatus 200 provides the image for the user. Instead, the image providing apparatus 200 may transmit the data of the image to the information input apparatus 300 without performing the processes of step S220 and step S230, and finish the flow of the series described with FIG. 5. In other words, the image providing apparatus 200 may provide the image without examining whether or not the user desires to acquire the image.

In the image providing system 10, the image providing apparatus 200 searches for, using the travelling history information of the vehicle 101 of the user and the image capturing information of the data of the video images, the data of the video image that has a possibility that the image that matches the conditions can be extracted from among the data of the video images. The image providing apparatus 200 can also search for, using the information of the license number of the vehicle 101 of the user instead, the data of the video image that has a possibility that the image that matches the conditions can be extracted. In this case, the image providing apparatus 200 first identifies the plurality of data of the video images received from the plurality of vehicles 100 by image identification processing. Next, the data of the video image that the license plate that coincides with the information of the license number of the vehicle 101 of the user is viewed in is extracted from among the identified plurality of data of the video images. After that, by using a tracking technology on the vehicle 101 of the user in the extracted video image, the image providing apparatus 200 recognizes that the vehicle 101 of the user is viewed even in the video image that the license number is not viewed in and performs the extraction. As above, the image providing apparatus 200 can search for the data of the video image that has a possibility that the image that matches the conditions can be extracted.

Based on a history of the providing for the user, the image providing apparatus 200 can also predict conditions for an image that the user seems to like and perform the extraction. The history of the providing for the user is a history of the past conditions for the wanted images and a history of the images having been provided, as to the identical user. The processing apparatus 210 of the image providing apparatus 200 accumulates the aforementioned providing histories in the storage apparatus 220. Next, the processing apparatus 210 predicts the conditions for the image that the user seems to like from the providing histories. For example, the processing apparatus 210 searches for the points that coincide with one another from among the history of the past conditions for the wanted images as to the identical user to predict the conditions for the image that the user seems to like. For example, the processing apparatus 210 identifies the features from among the history of the images provided in the past as to the identical user and searches for the points that coincide with one another in the plurality of images thereby to predict the conditions for the image that the user seems to like. After that, the processing apparatus 210 extracts, from among the data of the video images stored in the storage apparatus 220, an image that the vehicle of the user is viewed in and matches the predicted conditions for the image that the user seems to like.

What is claimed is:

1. An image providing apparatus connected to a plurality of vehicles each including a drive recorder and a plurality of information input apparatuses via a communication network, the image providing apparatus comprising:
a processing apparatus; and
a storage apparatus, wherein the processing apparatus of the image providing apparatus performs
receiving and storing data of a video image captured by the drive recorder from the plurality of vehicles and in the storage apparatus,
receiving information for identifying a vehicle of a user and a condition for a wanted image from the information input apparatus, the information and the condition being input to the information input apparatus by the user, and
extracting and providing, from among a plurality of the data of the video images stored in the storage apparatus and for the user, an image that the vehicle of the user is viewed in and matches the condition.

2. The image providing apparatus according to claim 1, wherein the condition includes information of capturing date and time and information of a capturing place of the image.

3. The image providing apparatus according to claim 2, wherein the condition further includes any of information of a background, information of an altitude of the capturing place, and information of an angle of the viewed vehicle of the user.

4. The image providing apparatus according to claim 1, wherein:
travelling history information is information in which positional information of the vehicle of the user at each time is recorded; and
the processing apparatus performs searching for data of a video image that has a possibility that the image that matches the condition is able to be extracted, from among the plurality of data of the video images stored in the storage apparatus, using the travelling history information received from the vehicle of the user and image capturing information including information of capturing dates and times and positional information of capturing places of the data of the video images, the image capturing information being received from the plurality of vehicles.

5. The image providing apparatus according to claim 1, wherein the processing apparatus performs
receiving, as the information for identifying the vehicle of the user, information including any of a vehicle type, a color, and a license number of the vehicle of the user from the information input apparatus, and
extracting the image that the vehicle of the user is viewed in from among the data of the video image using the information including any of the vehicle type, the color, and the license number of the vehicle of the user.
